(19) United States
(12) Patent Application Publication
(10) Pub. No.: US 2013/0238457 A1
(43) Pub. Date: Sep. 12, 2013

(54) Remote Payment System and Method

(71) Applicant: Hasan Ozgur Genc, Kocaeli (TR)

(72) Inventor: Hasan Ozgur Genc, Kocaeli (TR)

(73) Assignee: Turkcell Teknoloji Arastirma Ve Gelistirme Anonim Sirketi, Kocaeli (TR)

(21) Appl. No.: 13/807,644

(22) PCT Filed: Apr. 24, 2012
(86) PCT No.: PCT/IB12/52052

§ 371 Date: Dec. 28, 2012

(30) Foreign Application Priority Data
Mar. 12, 2012 (TR) 2012/02751

(51) Int. Cl. G06Q 20/38

(52) U.S. Cl. CPC G06Q 20/382
USPC 705/21; 705/44

(57) ABSTRACT

The present invention relates to a remote payment system (1) and method (100) which enables a customer who will carry out payment transaction to make payment without the necessity of being present at the store where s/he shops and the device, such as POS device, being used in the course of realizing the payment to be continuously on-line.

### TECHNICAL FIELD

The present invention relates to a remote payment system and method which enables a customer who will carry out payment transaction to make payment without the necessity of being present at the store where s/he shops and the device, such as POS device, being used in the course of realizing the payment to be continuously on-line.

### BACKGROUND OF THE INVENTION

For a shopping done today, online shopping (shopping over internet) is the most common method for a case when the person making the payment does not need to be present at the store where s/he shops during realization the payment transaction with respect to the shopping. Another example which can be given for the said remote shopping system is to carry out the sales transaction by methods which are not face-to-face such as telesales. In such cases payment is realized upon the amount to be paid is transferred to a bank account, the customer shares information of a debit card belonging to him/her with the seller verbally, in written or via an interface which is provided over internet in shopping done over internet and the seller uses the said card information. Realization of payment via money transfer into an account leads to a need to carry out an extra transaction other than shopping process for customer and seller. In addition to this, payment transaction and shopping cannot take place simultaneously and it is required to match the money transfer carried out with the shopping by the seller personally manually. Whereas payments which are made by the customer by sharing information of a debit card have a significant security risk with regards to customer.

The United States patent document no. US2010/0320266 discloses wireless sales transactions. More specifically, the United States patent document no. US2010/0320266 discloses transactions which are carried out using wireless device over a wide area network (WAN). In an embodiment of the invention described in said patent document, communication between the mobile device, the payment server, the service provider and the point-of-sale (POS) device is as follows: The point-of-sale device broadcasts its ID to a mobile device at first. The mobile device submits payment instructions to the payment server. The said payment instructions include information such as ID of the point-of-sale device, the payment amount, the payment method. The payment server acknowledges the instruction and requires authorization from the mobile device. It ensures that the user of the mobile device is an appropriate user and authorizes the transaction by inputting a code, such as a PIN code, to the mobile device. Thus, the mobile device authorizes the payment server to proceed with the transaction. The payment server sends the payment confirmation to the service provider. And the service provider network forwards the said confirmation to the point-of-sale device. The point-of-sale device sends the message relating to the payment acknowledgement to an element in the service provider network. This message is sent from the service provider to the payment server firstly and to the mobile device from there. Thus, the mobile device is notified of the acceptance of the payment.

### SUMMARY OF THE INVENTION

An objective of the present invention is to realize a payment system and method which has no risk of disconnection (timeout) of the device where the seller initiated the demand for payment with the server.

Another objective of the present invention is to realize a remote payment system and method which enables a customer who will carry out payment transaction to perform the payment transaction without the necessity of being present at the store where s/he shops following a remote shopping.

### DESCRIPTION OF THE INVENTION

The “Remote Payment System and Method” realized to fulfill the objectives of the present invention is shown in the figures attached, in which:

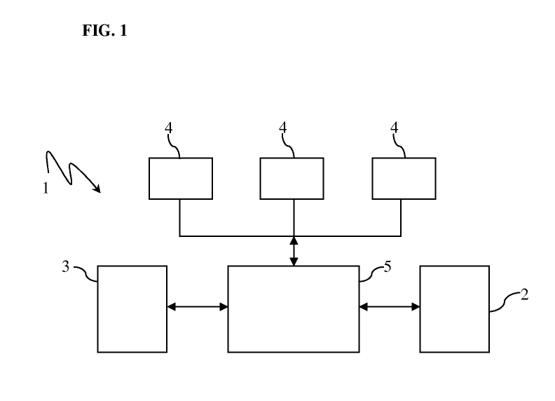

FIG. 1 is schematic view of the inventive remote payment system.

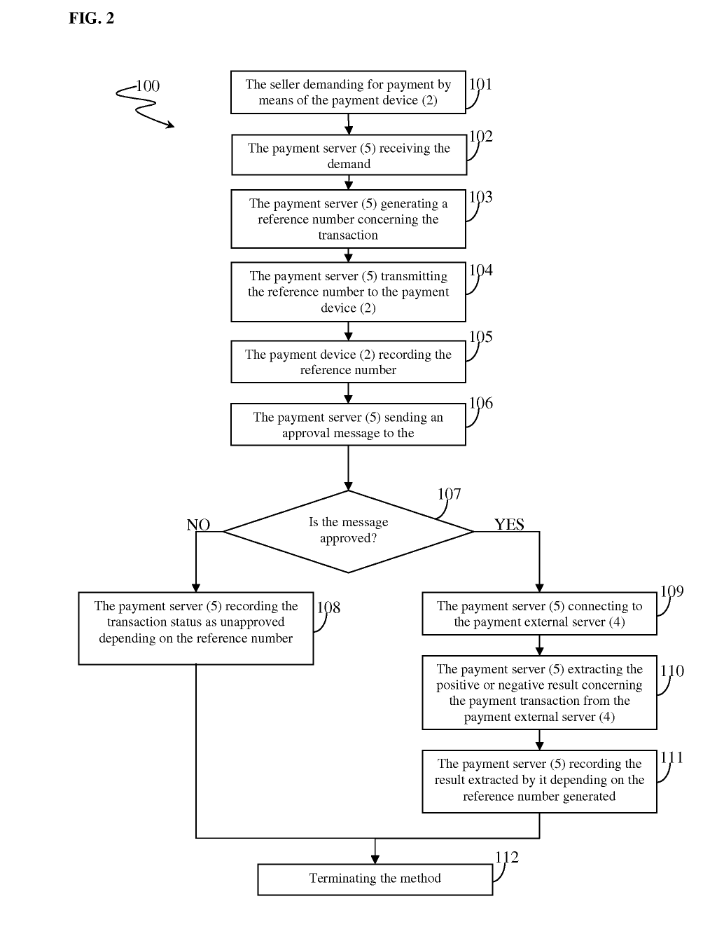

FIG. 2 is a flow chart of the inventive remote payment method.

The components illustrated in the figure are individually numbered, where the numbers refer to the following:
1. Remote payment system
2. Payment device
3. Communication device
4. Payment external server
5. Payment server
100. Remote payment method

The remote payment system (1) which enables to carry out payment transaction particularly in remote online-shopping comprises:
at least one payment device (2) which enables the seller to demand for payment in order to initiate the payment transaction after the customer completes shopping,
at least one communication device (3) which enables the customer to give the approval necessary for the payment transaction,
at least one payment external server (4) where the account (4) whereby the customer will make the payment is located, and
at least one payment server (5) which is in communication with the payment device (2), the communication device (3) and the payment external server (4); transmits at least one reference number concerning the transaction to the payment device (2) after the seller demands for payment by means of the payment device (2); and in accordance with the approval received from the customer by means of the communication device (3), contacts with the payment external server (4) and queries whether the payment is realized or not.

The payment device (2) provided in the inventive remote payment system (1) enables payment transaction to be initiated and followed by the seller. The said payment device (2) may be cash register, POS (point-of-sale) device, mobile telephone or any computer that is connected to internet and where custom developed-applications can be downloaded. In order that the payment concerning the shopping is realized after the customer completes his/her shopping, the seller transmits the demand for payment to the payment server (5) by means of the payment device (2). After the demand is transmitted to the payment server (5), the payment server (5) generates a reference number concerning the transaction and sends this number to the payment device (2). The seller can control whether the payment is made using the said reference number at will, by connecting to the payment server (5). Thus, the payment device (2) does not need to be online during all payment transaction.

The communication device (3) provided in the inventive remote payment system (1) is used for carrying out the payment transaction with respect to the shopping done by the customer. The said communication device (3) may be any computer, television or mobile telephone which can connect to internet. After the seller demands for payment, the customer is warned by means of the communication device (3) about approving the payment. The said warning can be given in text format or in an alternative embodiment of the invention it is given audibly. The customer approves or rejects the payment transaction by means of the communication device (3). Approval or rejection transaction carried out by the customer is transmitted to the seller from the communication device (3). In a preferred embodiment of the invention, the communication device (3) sends information of whether the customer gives approval or not to the mobile telephone of the seller in the form of a text message.

With the payment external server (4) provided in the inventive remote payment system (1), it is queried whether the customer has credit required for doing shopping after the customer gives approval necessary for completing the shopping by means of the communication device (3). The said payment external server (4) can be any bank server which enables the customer to make payment via credit or debit card or a mobile operator server which enables the customer to make payment by means of credits (prepaid) that s/he has or method of reflecting on the invoice via the mobile operator where the customer is a subscriber of. Upon the query of the payment server (5), the payment external server (4) determines whether the customer can make the payment or not and informs the payment server (5) by realizing the payment if the customer has sufficient balance or without realizing the payment.

The payment server (5) provided in the inventive remote payment system (1) is in communication with the payment device (2), the communication device (3) and the payment external server (4) and it enables to carry out the payment transaction in a coordinated and controlled manner. After the seller demands for payment, the payment server (5) generates a reference number concerning the transaction and transmits this number to the payment device (2). Upon the customer approves the payment transaction, the payment server (5) connects to the payment external server (4) and demands realization of the payment transaction. If the payment transaction is carried out or could not be carried out by the payment external server (4), the payment server (5) records the result of the transaction depending on the reference number generated by it independently of the result. Thus, the seller can see the result of the transaction whenever s/he wants by connecting to the payment server (5).

The remote payment method (100) which enables to carry out payment transaction particularly in remote online-shopping or telesales or face-to-face shopping when the customer does not has a means of payment such as debit card on him/her whereby s/he will make payment comprises steps of:
the seller demanding for payment by means of the payment device (2) (101);
the payment server (5) receiving the demand (102);
the payment server (5) generating a reference number concerning the transaction (103);
the payment server (5) transmitting the reference number to the payment device (2) (104);
the payment device (2) recording the reference number (105);
the payment server (5) sending an approval message to the communication device (3) (106);
the payment server (5) controlling the answer given by the customer to the approval message (107);
if the customer did not give approval concerning the payment transaction, the payment server (5) recording the transaction status as unapproved depending on the reference number (108) and terminating the method (112);
if the customer gave approval concerning the payment transaction, the payment server (5) connecting to the payment external server (4) (109);
the payment server (5) extracting the positive or negative result concerning the payment transaction from the payment external server (4) (110);
the payment server (5) recording the result extracted by it depending on the reference number generated (111) and terminating the method (112).

In the inventive remote payment method (100), after the customer completes his/her remote shopping the seller demands for payment concerning the shopping done by means of a payment device (2) such as a POS device (101). The said payment demand is received by the payment server (5) (102) and a reference number is generated concerning the transaction (103). The reference number generated is transmitted from the payment server (5) to the payment device (2) (104). The payment device (2) records the reference number received from the payment server (5) (105). Then, the payment server (5) sends a message to a communication device (3), such as a mobile telephone, of the customer in order that the payment transaction is approved (106). The payment server (5) controls whether approval is given from the communication device (3) (107). If the customer did not give approval concerning the payment transaction or the predetermined time for approval is run out, the payment server (5) records the information that the transaction is not approved such that it will be based on the reference number (108) and the method is terminated (112). If it is determined that the customer approved the payment transaction as a result of the control process (107), the payment server (5) connects to a payment external server (4) such as bank server or mobile operator server (109). Then, the payment server (5) extracts information that whether the payment transaction is realized or not from the payment external server (4) (110). After the said information is extracted, the payment server (5) records the result information of the transaction such that it will be based on the reference number (111) and the method is terminated (112). The seller can see whether the payment transaction is realized or not by connecting to the payment external server (4) whenever s/he wants using the payment device (2) and the reference number recorded in the device (2). With the reference number generated by the payment server (5) and being able to follow the payment over the payment server (5) using the said reference number, the payment device (2) does not need to be continuously online during the payment transaction.

In an alternative embodiment of the inventive remote payment method (100), after the customer gives approval concerning the payment transaction by means of the communication device (3), the payment server (5) informs the seller that the payment transaction is approved by preferably sending a message to mobile telephone of the user.

In an embodiment of the inventive remote payment method (100), the customer approves the approval message reaching his/her communication device (3) by selecting the payment external server (4) where s/he will make the payment.

In an embodiment of the inventive remote payment method (100), the customer approves the approval message reaching his/her communication device (3) by entering a previously determined password into his/her communication device (3).

In the inventive remote payment system (1) and method (100), the payment device (2) does not need to be online during the payment transaction due to the fact that the payment server (5) generates a reference number concerning the transaction after it receives the demand for payment, transmits the reference number to the payment device (2) and the payment device (2) records the said reference number. Thus, in the event that realization of the payment approval takes a long time risk of disconnection (timeout) of the payment device (2) where the seller initiated the demand for payment with the payment server (5).

It is possible to develop various embodiments of the inventive “remote payment system (1) and method (100)”, it cannot be limited to examples disclosed herein and it is essentially according to claims.

1. A remote payment system (1) which enables carrying out a payment transaction particularly in remote online-shopping or telesales or face-to-face shopping when a customer does not have a means of payment such as a debit card on the customer whereby the customer will make payment comprising:
at least one payment device (2) which enables a seller to demand for payment in order to initiate the payment transaction after the customer completes shopping,
at least one communication device (3) which enables the customer to give the approval necessary for the payment transaction,
at least one payment external server (4) where an account (4), whereby the customer will make the payment, is located,
and characterized by
at least one payment server (5) which is in communication with the payment device (2), the communication device (3) and the payment external server (4); transmits at least one reference number concerning the transaction to the payment device (2) after the seller demands for payment by means of the payment device (2); and in accordance with the approval received from the customer by means of the communication device (3), contacts with the payment external server (4) and queries whether the payment is realized or not.

2. A remote payment system (1) according to claim 1, characterized by a payment device (2) which is a cash register.

3. A remote payment system (1) according to claim 1, characterized by a payment device (2) which is a POS device.

4. A remote payment system (1) according to claim 1, characterized by a payment device (2) which is a mobile telephone.

5. A remote payment system (1) according to claim 1, characterized by a payment device (2) which is any computer that is connected to the internet and where custom developed-applications can be downloaded.

6. A remote payment system (1) according to claim 1, characterized by a payment device (2) which is a computer that can connect to the internet.

7. A remote payment system (1) according to claim 1, characterized by a payment device (2) which is a television that can connect to the internet.

8. A remote payment system (1) according to claim 1, characterized by a payment device (2) which is a mobile telephone.

9. A remote payment system (1) according to claim 1, characterized by the payment external server (4) which is any bank server that enables the customer to make payment by credit or debit card.

10. A remote payment system (1) according to claim 1, characterized by the payment external server (4) which is a mobile operator server that enables the customer to make payment by means of credits (prepaid) that the customer has or a method of reflecting on an invoice via the mobile operator where the customer is a subscriber of.

11. A remote payment system (1) according to claim 1, characterized by the payment server (5) which generates a reference number concerning the transaction and transmits this number to the payment device (2) after the seller demands for payment.

12. A remote payment method (100), characterized by steps of:
a seller demanding for payment by means of a payment device (2) (101);
a payment server (5) receiving a demand (102);
the payment server (5) generating a reference number concerning a payment transaction (103);
the payment server (5) transmitting the reference number to the payment device (2) (104);
the payment device (2) recording the reference number (105);
the payment server (5) sending an approval message to a communication device (3) of a customer (106);
the payment server (5) controlling an answer given by the customer to the approval message (107);
if the customer did not give approval concerning the payment transaction, the payment server (5) recording a transaction status as unapproved depending on the reference number (108) and terminating the method (112);
if the customer gave approval concerning the payment transaction, the payment server (5) connecting to a payment external server (4) (109);
the payment server (5) extracting a positive or negative result concerning the payment transaction from the payment external server (4) (110);
the payment server (5) recording the result extracted by it depending on the reference number generated (111) and terminating the method (112) particularly in remote online-shopping or telesales or face-to-face shopping when the customer does not have a means of payment such as a debit card on the customer whereby the customer will make payment.

13. A remote payment method (100) according to claim 12, characterized in that the payment server (5) informs the seller that the payment transaction is approved by sending a message to a mobile telephone of the seller, after the customer gives approval concerning the payment transaction by means of the communication device (3).

14. A remote payment method (100) according to claim 12, characterized in that the customer approves the approval message reaching the communication device (3) of the customer by selecting the payment external server (4) where the customer will make the payment.

15. A remote payment method (100) according to claim 12, characterized in that the customer approves the approval message reaching the communication device (3) of the customer by entering a previously determined password into the communication device (3) of the customer.

16. A remote payment method (100) according to claim 13, characterized in that
the customer approves the approval message reaching the communication device (3) of the customer by selecting the payment external server (4) where the customer will make the payment.

17. A remote payment method (100) according to claim 13, characterized in that the customer approves the approval message reaching the communication device (3) of the customer by entering a previously determined password into the communication device (3) of the customer.

18. A remote payment method (100) according to claim 14, characterized in that the customer approves the approval message reaching the communication device (3) of the customer by further entering a previously determined password into the communication device (3) of the customer.
